(19) United States
(12) Patent Application Publication
(10) Pub. No.: US 2014/0258165 A1
(43) Pub. Date: Sep. 11, 2014

(54) Inventory Tracking System

(71) Applicant: THERMO FISHER SCIENTIFIC INC., Waltham, MA (US)

(72) Inventor: Steven J. Heil, McMurray, PA (US)

(73) Assignee: THERMO FISHER SCIENTIFIC INC., Waltham, MA (US)

(21) Appl. No.: 13/788,650

(22) Filed: Mar. 7, 2013

(51) Int. Cl. G06Q 10/08

(52) U.S. Cl. CPC G06Q 10/0833
USPC 705/333; 235/494

(57) ABSTRACT

Methods and systems for tracking inventory. A method of tracking a container of a chemical includes labeling the container with a machine readable code that includes data which uniquely identifies the container and/or its contents. Historical data concerning the shipment and/or use of the container or its contents, or any other data specific to the container may be stored in a database that associates data with the specific container based on the unique identifier. An inventory management system may then automatically track a specific container by scanning the machine readable code to identify the specific container, and then accessing the database to both store and retrieve data related to the scanned container and/or its contents.

### FIELD OF THE INVENTION

The present invention relates generally to methods and systems for inventory management and, more particularly, to methods and systems for tracking inventory of individual product containers containing chemicals or reagents.

### BACKGROUND OF THE INVENTION

Bulk products, such as chemicals and reagents, are typically supplied to customers in the form of a container that holds a specific amount of the product. For example, a product may be supplied in a container that holds 500 milliliters of a reagent or 500 grams of a powdered chemical. To identify the product in the container, a label is typically applied to the container by the supplier. These labels include information that identifies the type of product in the container (e.g., “Sulfur, Precipitated Powder”), the amount of product (e.g., “500 grams”), and other information regarding the product, such as catalog or part number, health hazards associated with exposure to the chemical, an expiration date for the product, etc.

To facilitate automatic identification of products contained in the container, barcodes have been added to container labels that duplicate much of the information provided on the label in human readable form. These barcodes allow information included on the label to be quickly scanned into various types of computer systems, such as an inventory system. Barcodes thus allow information regarding the contents of the container to be quickly and accurately identified. As a container of a chemical product moves from the supplier to a distributor and finally to the customer, the bar code may be scanned at various times to obtain the data contained therein. This data may be used, for example, to populate shipping and receiving forms and/or purchase orders, thereby reducing the amount of manual labor required in filling out these forms.

Although conventional labels having barcodes have improved product tracking, particularly with regard to shipping the container from the supplier to the customer, these labels fail to provide information regarding events experienced by that specific product container. That is, the data provided on the label is limited to information describing the product at the time the label was applied by the supplier. Conventional labels are thus incapable of providing data to users regarding events such as when and where the product container was shipped or received, how the product has been used by the customer, or other events that must be entered into an inventory system manually, if they are tracked at all.

Thus, there is a need for improved methods and systems of tracking and managing containers of chemicals and reagents that provide historical information of events experienced by the container and the product therein, and that reduce the potential for human error through manual entry of historical information into an inventory tracking system.

### SUMMARY OF THE INVENTION

The present invention overcomes the foregoing problems and other known shortcomings, drawbacks, and challenges of tracking inventory and use of chemicals and reagents in containers such as bottles in a complex distribution and/or use environment. While the present invention will be described in connection with certain embodiments, it will be understood that the present invention is not limited to these embodiments. To the contrary, the present invention includes all alternatives, modifications, and equivalents as may be included within the spirit and scope of the present invention.

In one embodiment of the present invention, a method is provided that tracks a container of a product using a reading device. The method includes providing a first machine readable code on the container that includes first data that uniquely identifies the container, providing second data relating to the container and/or a product in the container to a database, and associating the first data and the second data in the database. The method further includes receiving a message in the database that includes the first data and third data and updating the second data in the database based on the third data in the message, the third data being time variable data relating to events associated with the container.

By way of example and without limitation to this embodiment, the first data may include data defining a lot number of the product in the container, a lot analysis of the product in the container, an expiration date of the product in the container, and/or a serial number of the container. In addition, the second data may include data relating to a location of the container, an amount of the product in the container, a status of the container, and/or a purchase order for the container, and the third data may include data relating to a location of the container, an amount of the product in the container, a status of the container, and/or a purchase order for the container. The method may also include providing a second machine readable code on the container, the second machine readable code including fourth data relating to an event associated with the container. This fourth data may include a purchase order number, an order shipping date, a desired delivery location, a desired delivery date, a notification of a requirement for a certificate of conformity, a notification of a requirement for a certificate of analysis, and/or a notification of a requirement for a material safety datasheet.

In another embodiment of the present invention, a method is provided for tracking a container of a product using a reading device. The method includes providing a machine readable code on the container that includes first data which uniquely identifies the container, providing second data to a database that relates to the container and/or a product in the container, and associating the first data and the second data in the database. The method further includes reading the machine readable code on the container with the reading device and transmitting a message to the database from the reading device that includes data indicative of an amount of the product, and updating the second data in the database based on the data indicative of the amount of the product.

By way of example and without limitation to this embodiment, the first data may include data defining a lot number of the product in the container, a lot analysis of the product in the container, an expiration date of the product in the container, and/or a serial number of the container. In addition, the second data may include data relating to a location of the container, an amount of the product in the container, a status of the container, and/or a purchase order for the container.

In yet another embodiment of the present invention, a label is provided for labeling one container of a plurality of containers of a product. The label includes a first machine readable code including first data that uniquely identifies the one container by indicating: (1) a unique number that is not repeated across a product or container, (2) a combination of a number and a product designator that can occur on only one container of the plurality of containers, or (3) a combination of a serial number, a product identifier, and a lot number that occurs on only one container of the plurality of containers. In each case, the first data is associated in a database with second data relating to the container. This second data may, for example and without limitation, include data relating to a location of the container, an amount of the product in the container, a status of the container, and/or a purchase order for the container.

In yet another embodiment of the present invention, a system is provided for tracking a container of a product using a reading device. The system includes a processor and a memory storing instructions that, when executed by the processor, cause the processor to provide a first machine readable code on a container that includes first data which uniquely identifies the container, provide second data to a database that relates to the container and/or a product in the container, and associate the first data and the second data in the database. The instructions further cause the processor to receive a message in the database that includes the first data and third data, and update the second data in the database based on the third data in the message, the third data being time variable data relating to events associated with the container.

By way of example and without limitation to this embodiment, the first data may include data defining a lot number of the product in the container, a lot analysis of the product in the container, an expiration date of the product in the container, and/or a serial number of the container. In addition, the second data may include data relating to a location of the container, an amount of the product in the container, a status of the container, and/or a purchase order for the container, and the third data may include data relating to a location of the container, an amount of the product in the container, a status of the container, and/or a purchase order for the container.

In yet another embodiment of the present invention, a computer program product is provided. The computer program product includes a non-transitory computer readable storage medium and program instructions stored on the computer readable storage medium. When executed by a processor, the program instructions cause the processor to provide a first machine readable code on a container that includes first data which uniquely identifies a container, provide second data to a database that relates to the container and/or a product in the container, and associate the first data and the second data in the database. The program instructions are further configured to cause the processor to receive a message in the database that includes the first data and third data, and update the second data in the database based on the third data in the message, the third data being time variable data relating to events associated with the container.

By way of example and without limitation to this embodiment, the first data may include data defining a lot number of the product in the container, a lot analysis of the product in the container, an expiration date of the product in the container, and/or a serial number of the container. In addition, the second data may include data relating to a location of the container, an amount of the product in the container, a status of the container, and/or a purchase order for the container, and the third data may include data relating to a location of the container, an amount of the product in the container, a status of the container, and/or a purchase order for the container.

### BRIEF DESCRIPTION OF THE DRAWINGS

The accompanying drawings, which are incorporated in and constitute a part of this specification, illustrate embodiments of the present invention and, together with a general description of the present invention given above, and the detailed description of the present invention given below, serve to explain the principles of the present invention.

FIG. 1 is a schematic block diagram illustrating a mobile device and a hardware platform in communication via a network in accordance with an embodiment of the present invention.

FIG. 2 is a schematic block diagram illustrating the mobile device of FIG. 1 scanning a container having a label, the mobile device in communication with a plurality of databases in accordance with an embodiment of the present invention.

FIG. 3 is a diagrammatic view of the label in FIG. 2 including machine readable code.

FIG. 4 is a flow chart illustrating interactions between a system user, a mobile application on the mobile device, the machine readable code, and the plurality of databases of FIG. 3 in accordance with an embodiment of the present invention.

FIG. 5 is a flow chart illustrating interactions between the system user, mobile application, machine readable code, and plurality of databases of FIG. 4 in accordance with an alternative embodiment of the present invention.

FIG. 6 is a flow chart illustrating interactions between the system user, mobile application, machine readable code, and plurality of databases of FIG. 4 in accordance with another alternative embodiment of the present invention.

FIG. 7 is a flow chart illustrating interactions between the system user, mobile application, machine readable code, and plurality of databases of FIG. 4 in accordance with yet another alternative embodiment of the present invention.

FIG. 8 is a flow chart illustrating interactions between the system user, mobile application, machine readable code, and plurality of databases of FIG. 4 in accordance with yet another alternative embodiment of the present invention.

### DETAILED DESCRIPTION OF THE PREFERRED EMBODIMENT

Embodiments of the present invention provide methods and systems for tracking inventory and use of chemical and reagent products in small containers from a supplier through an end user. To this end, an inventory tracking system allows users to track inventory and update one or more inventory databases by scanning machine readable code on a product label. The machine readable code may be scanned with a mobile scanning device, such as a smart phone or tablet computer loaded with a mobile application so that product labels can be scanned wherever they are found. However, alternative embodiments of the present invention may have the application implemented on any type of computing or scanning device, such as a desktop computer in a stockroom. The machine readable code contains data that allows the inventory tracking system to uniquely identify the particular product container (e.g., bottle) to which the label is affixed, even though the particular product container (e.g., bottle) may have been packaged or shipped in a larger container (e.g., case or pallet) at some point in its distribution. The system is thereby able to track data specific to that container, such as a product lot number, an analysis of the properties of the product in the container, an amount of product left in the container, and the location of container, to name but a few of the types of data that may be tracked. This container specific data may be stored in the machine readable code, or in a database accessed by the mobile application based on data obtained from the machine readable code.

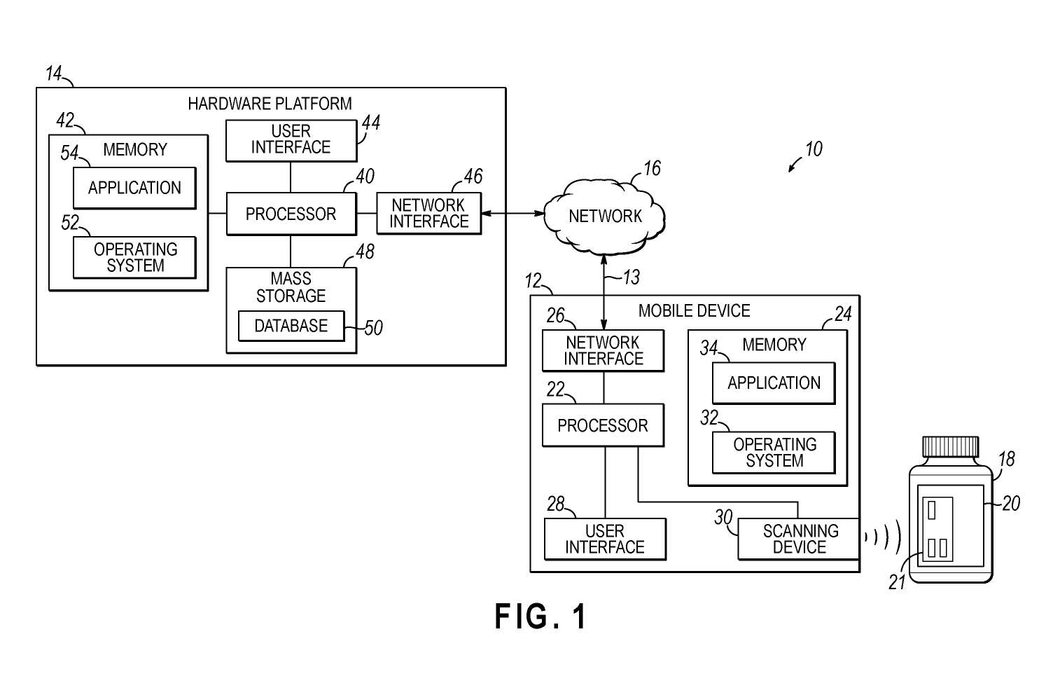

Referring now to FIG. 1, and in accordance with an embodiment of the present invention, an inventory tracking system 10 includes a reading device, such as mobile device 12, and a hardware platform 14 in communication with the mobile device via a network 16. The inventory tracking system 10 is particularly designed to track a product container 18 containing a chemical or reagent and also to track the quantity of such contents as may change over time. To this end, the product container includes a label 20 that includes one or more machine readable codes 21. The mobile device 12 may be a smart phone, a tablet computer, or any other device suitable for scanning machine readable code and communicating with the hardware platform 14 and/or other system resources over the network 16. The network 16 may include one or more local access networks (LANs), wireless networks (private or commercial), and/or publically accessible networks, such as the Internet, that communicatively couple the mobile device 12 and the hardware platform 14.

The mobile device 12 may be coupled to the network using any suitable communication link 13, but will typically employ a wireless communication link. To this end, the network 16 may include a wireless access point (not shown) that provides a wireless interface, such as an IEEE 802.11 air interface (commonly known as Wi-Fi) that operatively couples the mobile device 12 to the network 16. The network 16 may thereby allow the mobile device 12 to establish the communication link 13 as needed to communicate with the hardware platform 14 and/or any other computer resources connected to the network 16 without requiring the mobile device 12 be tethered to the network 16. The communication link 13 may also be provided by a wireless carrier that provides network access through a suitable commercial air interface, such as WiMax, GPRS, EDGE, 1xRTT, EV-DO, and/or UMTS. In any case, persons having ordinary skill in the art of computer networks will understand that any suitable wireless or wire-line protocol may be employed to provide communication between the mobile device 12 and the network 16, and the present invention is not limited to a specific type of mobile device 12, communication link 13 or network 16. Persons having ordinary skill in the art will further understand that embodiments of the present invention also include devices that provide the functions of the mobile device 12, but that are tethered to the network. For example, a desktop computer may be used to scan the label 20 of container 18 as containers are received and/or checked out of a stockroom or warehouse environment.

The mobile device 12 includes a processor 22, a memory 24, a network interface 26, a user interface 28, and a scanning device 30. The processor 22 may include one or more processors selected from microprocessors, micro-controllers, digital signal processors, microcomputers, central processing units, field programmable gate arrays, programmable logic devices, state machines, logic circuits, and/or any other devices that manipulate signals (analog and/or digital) based on operational instructions that are stored in memory 24. Memory 24 is operatively coupled to the processor 22, and may be a single memory device or a plurality of memory devices including but not limited to read-only memory (ROM), random access memory (RAM), volatile memory, non-volatile memory, static random access memory (SRAM), dynamic random access memory (DRAM), flash memory, cache memory, and/or any other device capable of storing data.

Processor 22 may operate under the control of an operating system 32 that resides in memory 24. When present, the operating system 32 manages the mobile device resources so that program code embodied as one or more applications 34 residing in memory 24 may have instructions executed by the processor 22. In an alternative embodiment, the application 34 may be executed by the processor 22 directly, in which case the operating system 32 may be omitted. The network interface 26 of mobile device 12 may include suitable radio transceiver circuitry. The network interface 26 may thereby be configured to support a wireless communication link 13 between the mobile device 12 and the network 16.

The user interface 28 is operatively coupled to the processor 22 of mobile device 12, and includes at least one output device and one input device. Suitable output devices for the mobile device 12 include, but are not limited to, a touch screen, an alphanumeric display, an audio transducer, and/or any other visual, audible, and/or tactile indicator. Likewise, suitable input and/or control devices include, but are not limited to, the aforementioned touch screen, an alphanumeric keyboard or keypad, a pointing device, pushbuttons, a microphone, and/or any other device capable of accepting commands or input from the user and transmitting the entered input to the processor 22. The user interface 28 thereby provides a mechanism whereby a user may input data to, and receive data from, the processor 22.

The scanning device 30 is configured to scan the machine readable code 21, the most common forms of which are referred to as a barcode (in the case of a 1-dimensional code) or a Quick Response (QR) code (in the case of a 2-dimensional code). Although the embodiments of the present invention described herein are generally described as using printed barcodes and/or QR codes on a product label, it should be understood that some embodiments of the present invention may be used with other devices configured to store data on a product package, such as a Radio Frequency Identity (RFID) tag attached to an outer container such as a case of bottles or a pallet of cases. The term “machine readable code” should therefore not be considered as limiting the present invention to barcodes and/or QR codes as a method of storing data on the label 20.

To obtain data from the machine readable code 21, the scanning device 30 may include a light source, such as a laser, that illuminates the machine readable code 21 and a photo detector that generates an electrical signal in response to light reflected from the code 21. The scanning device 30 may, in addition to or instead of the light source and photo detector, include an image capturing device (e.g., a digital camera) that captures images representative of the surrounding environment. These captured images may be processed into any suitable digital image file format known in the art, such as a raw image file, bit map, or Joint Photographic Experts Group (JPEG) formatted image (to name but a few) by the processor 22 and stored in memory 24. A digital image processing technique may then be used by the mobile application 34 to decode any machine readable code 21 that appears in the captured image. In embodiments of the present invention including an RFID tag, the scanning device 30 may also include a radio transceiver (not shown) configured to transmit RF signals that activate the RFID tag, and receive RF signals from the RFID tag that are transmitted in response to said activation.

Similarly as described with respect to the mobile device 12, the hardware platform 14 includes one or more processors 40, a memory 42, a user interface 44, and a network interface 46. The network interface 46 provides a communication link between the processors 40 and the network 16 using a suitable network communication protocol, such as Transmission Control Protocol/Internet Protocol (TCP/IP) over Ethernet.

The user interface 44 includes one or more suitable output devices, such as a color monitor or other visual display, one or more speakers, one or more formatted electronic media writers, such as a flash memory card, memory stick, USB-stick, CD, magnetic disk, and/or any other suitable output devices capable of storing data or conveying data to the system user. The user interface 44 also includes suitable input devices such as an alphanumeric keyboard, a pointing device or mouse, a touch pad, a microphone, one or more readers of the aforementioned formatted electronic media, or any other input devices capable of accepting commands or input from the user and transmitting the entered input to the processor 40.

The hardware platform 14 may also include mass storage device 48. The mass storage device 48 may comprise a single mass storage device or a plurality of mass storage devices including but not limited to hard drives, optical drives, tape drives, non-volatile solid state devices and/or any other device capable of storing digital data. A database 50 residing in memory 42 or the mass storage device 48 (shown) may include product data so as to provide a searchable database that receives data from, and provides data to, one or more system applications, such as the mobile application 34. Although shown as a single database 50, database 50 may include multiple databases 50 configured to support various system functions. Examples of databases 50 that may be supported include supplier databases, distributor databases, requisition databases, inventory databases, and/or customer-specific databases. Moreover, one or more of these databases 50 may be provided as a service over the network 16 as part of a cloud computing system.

The hardware platform processor 40 typically operates under the control of an operating system 52 that resides in memory 42 and executes program code embodied as one or more inventory tracking system applications 54 residing in memory 42. The one or more applications 54 may include a plurality of program modules and/or programs that support various inventory tracking system functions. Exemplary system functions include, but are not limited to, requisition/purchasing programs, a database search programs, shell programs, and graphic user and/or machine-machine interface programs for listing and updating product data. These applications 54 may access the database 50 and provide data to, and store data from, the mobile application 34 in response to requests received over the network 16. One or more of these applications 54 may also be copied from the hardware platform 14 to another memory, such as the memory 24 of mobile device 12, as needed to perform functions related to the operation of the inventory tracking system 10.

Although illustrated as a single platform in FIG. 1 for simplicity's sake, it should be understood that the hardware platform 14 may include a plurality of hardware platforms and/or a plurality of software programs. Moreover, various program code described herein may be identified based upon the application or software component within which it is implemented in a specific embodiment of the present invention. However, it should be appreciated that any particular program nomenclature used herein is merely for convenience, and thus the present invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the present invention is not limited to the specific organization and allocation of program functionality described herein.

Thus, persons skilled in the art will recognize that the exemplary operational environment illustrated in FIG. 1 is not intended to limit the present invention. Embodiments of the present invention may therefore include alternative hardware and/or software environments, and incorporate different numbers and configurations of hardware and software resources without departing from the scope of the present invention.

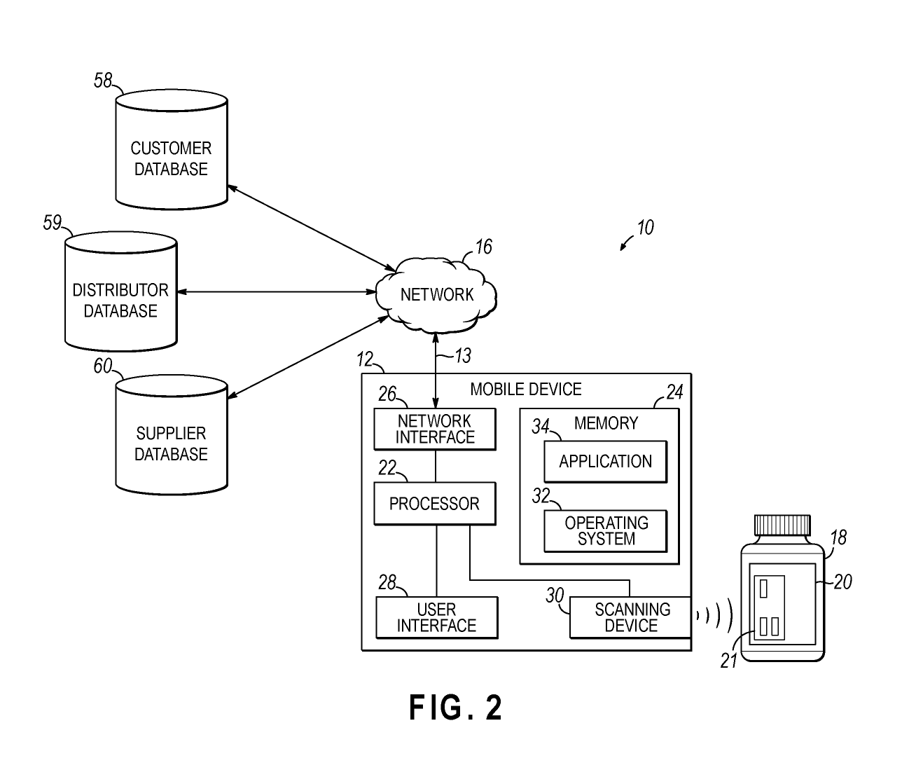

Referring now to FIG. 2, an exemplary embodiment of the inventory management system 10 is illustrated with database 50 divided into a plurality of databases 58-60, shown as a customer database 58, a distributor database 59, and a supplier database 60. Each database 58-60 may share the hardware platform 14 and/or reside within the memory 42 and/or mass storage device 48, may be hosted on a separate hardware platform (not shown), and/or may be provided as a network service (e.g., provided by a cloud computing system). In embodiments in which the databases 58-60 are hosted on separate platforms, the databases 58-60 may be communicatively coupled to each other via the network 16. In any case, the databases 58-60 are communicatively coupled to the mobile device 12 by the network 16. The mobile application 34 may thereby interact with the plurality of databases 58-60 to retrieve and store data relating to one or more containers 18 containing an amount of a chemical or reagent product. The customer database 58 may be a customer specific database maintained by the customer, the supplier, or the distributor.

Although three databases are illustrated in this exemplary embodiment, a person having ordinary skill in the art would understand that additional databases, or fewer databases, may be connected to the network 16, and that the additional databases could be accessed by the mobile application 34 as well as by any other computer applications of the inventory management system 10. Moreover, it should be further understood that the term “database” as used herein may include computing systems and services (e.g., e-business or and/or product inventory systems) or any other computer resource of the inventory tracking system 10 with which interaction is being described. That is, the term “database” is not limited to functions, programs, and platforms associated with storing, organizing, and searching data, and may be used to refer to any computer resource used to support the inventory system 10.

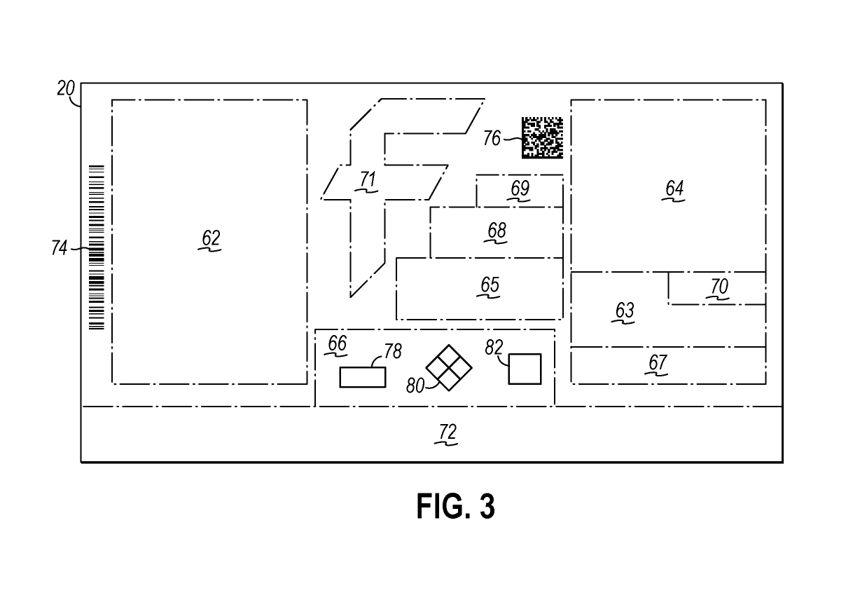

Referring now to FIG. 3, and in accordance with an embodiment of the present invention, the product label 20 is illustrated with a plurality of regions 62-72 that include text or other indicia in a human readable form, and a plurality of machine readable codes, such as a 1-dimensional or barcode 74, and a 2-dimensional or Quick Response (QR) code 76.

As shown in the exemplary embodiment illustrated in FIG. 3, a label 20 configured specifically for chemical containers includes a user precautions region 62. The user precautions region 62 may include an appropriate precautionary signal word, such as “DANGER”, “WARNING”, or “CAUTION” in addition to data concerning possible hazards associated with the contents of the container. Exemplary hazard data might include the toxicity, corrosiveness, and/or flammability of the product, symptoms of exposure to the product (e.g., headache), methods of exposure to the product (e.g., absorption through the skin), target organs affected, appropriate medical treatment, etc.

A product information region 63 may include data describing the product, such as a molecular formula, molecular weight, and/or Chemical Abstract Service (CAS) registry number. A lot analysis results region 64 may list the results of tests performed on the production lot from which the chemical or reagent in the container was obtained and filled. These test results may include, for example, assay, color, density, and the specific amounts (as a percentage or in parts per million or parts per billion) of various identified impurities or types of impurities in the product, to name but a few of the possible test results.

A product descriptor region 65 may include the common name and purity grade for the product (e.g., Acetonitrile, 0.2 micron filtered). A user alert region 66 may include personal protection information in an easily readable format, such as by using color codes and standardized symbols. To this end, the user alert region 66 may include a safety code 78, a National Fire Protection Association (NFPA) code 80, and a storage code 82 that provides information regarding safe storage conditions for the product.

A shipper's information region 67 may include U.S. Department of Transportation (DOT) shipping information, such as the proper shipping name and a UN/NA Number that provides a United Nations/North American numerical designation for transportation hazards. Other regions may provide additional details regarding the container or product, such as a part number 68 (e.g., a catalog or other part number that identifies the product), the container size 69 (e.g., volume or weight of product in a full container), a lot number 70 for the product associated with chemical or reagent products and filling of multiple containers from a single production lot, a trademark or other product source identifying symbol 71, and an address of the product manufacturer 72.

The machine readable codes 74, 76 may include data that duplicates all or part of the information included in the regions 62-72 of label, and may also include additional data not provided in user readable form. In many embodiments of the present invention, the barcode 74 (if present) will include at least the catalog or other part number found in region 68 in human readable form on the label 20, so that this portion of the data can be read into an electronic device by scanning the barcode 74. Barcodes containing such product identifier are conventionally used for chemicals, reagents and other products.

Data relating to the container and the product contained therein may be classified into a plurality of categories: (1) invariant data, (2) container variable data, and (3) time variable data. The data provide by the regions 62-72 of label 20 will typically be either invariant data or container variable data. Invariant data includes data that is constant across containers of the same product, and that does not change over time. Examples of invariant data typically include data found in the user precautions region 62, the product information region 63, product descriptor region 65, the user alert region 66, the shipper's information region 67, the part number region 68, the container size 69, and the manufacturer address 73.

Container variable data is data that can vary between containers of the same product. Examples of container variable data include data provided in the lot analysis region 64, the lot number 70, an expiration date, and a product serial number that uniquely identifies the specific container to which the label 20 is attached. However, because container variable data may vary from one container to the next, this type of data must be added to the label 20 using a process that differentiates between containers of the same product. That is, the regions of the label 20 that include container variable data cannot be printed on the label 20 until after variable characteristics associated with the container are identified, e.g., after a specific product sample is put into or otherwise identified with the container 18. Therefore, the data in these regions is typically applied to the label 20 during a second printing application that is performed after the label 20 has been associated with a specific container 18. In an embodiment of the present invention, the second printing application may be performed as part of the packaging process after the label 20 has been applied to the container 18 and the container 18 is filled with product. In this way, the variable data regarding the product in the container 18 can be determined after the label 20 has been applied. However, the second printing application may also occur after the label 20 has been associated with, or otherwise assigned to, the container 18, but before the label 20 has been applied to the container 18.

Time variable data may include data relating to events associated with the container that occur over time, such as data that tracks the history of the container. Examples of time variable data includes the location of the container 18 and the amount of the product left in the container 18. Because this data can change with time in an unpredictable manner, it may be stored in one or more of the databases 58-60 and updated each time a change is detected. However, time variable data (such as date of packaging, date of shipment, date of shipment, date of transfer) could also be added to the label 20 by printing an additional machine readable code on the label 20, or by updating data stored in an RFID tag included in the label 20 or otherwise associated with the container 18, as will be described in greater detail below.

The QR code 76 may be applied to the label 20 in a number of ways. For example, the label 20 may be printed in a single printing operation prior to the label 20 being applied to the container 18, so that the human readable information 62-72, the barcode 74, and the QR code 76 are all printed on the label 20 prior to placing the label 20 on the container 18. The label 20 may also be printed using multiple printing applications, with each operation applying different regions 62-72 and/or codes 74, 76 to the label 20. For example, the label may be printed using two separate printing applications, with both applications being performed prior to the label 20 being applied to the bottle.

Under this printing scenario, the portions or regions of the label 20 containing invariant data could be applied in one printing operation. These invariant portions of the label 20 would include the barcode 74 in cases where the barcode 74 merely duplicates the invariant human readable data in a machine readable form. The QR code 76 and, optionally, additional human readable information, would then be applied in a separate printing application configured to apply container variable data to the label. The separate printing applications could both be performed prior to the label 20 being applied to the container 18. In an alternative embodiment of the present invention, the human readable regions 62-72 and barcode 74 could be printed prior to applying the label 20 to the container, and the QR code 76 printed on the label 20 after applying the label 20 to the container 18. Different portions of the label 20 may thereby be printed at different points in the product packaging process. For example, one printing application may occur prior to the label 20 being associated with the container 18, and another printing application may occur after the label 20 has been associated with the container 18.

In an embodiment of the present invention, the QR code 76 includes data that identifies the product (e.g., a part number or catalog number) and a unique identifier specific to the container to which the label 20 is attached. Optionally, the QR code 76 may also include additional data that is generally applicable to the product (e.g., storage or hazard codes), data that identifies a packaging lot number as well as data applicable to the packaging lot (e.g., an expiration date for the packaging lot).

The unique identifier for the specific container 18 may be any number or combination of characters, numbers, and/or other symbols that is capable of uniquely identifying the container 18. That is, a particular unique identifier must be specific to the label 20 on which it appears, so that the unique identifier is only found on that label 20. The requirements of the unique identifier can be satisfied by, for example: (1) a unique number that is not repeated across any product or container (e.g., a container serial number); (2) a combination of a number and a product designator that can only occur only on one label, e.g., a number that is unique within a particular product type; or (3) a combination of a number, a product identifier, and a lot number that can only occur only on one label.

For example, assume that 100,000 labels 20 for ACETONITRILE are printed at one time, with each label 20 including the barcode 74 and QR code 76. The barcode 74 could include data (e.g., a four character product designator “ACET”) identifying the product in the container as ACETONITRILE, and the QR code 76 data could include a non-repeating serialized number ranging from 00000 to 99999 and the product designator ACET. Each QR code 76 would thereby include data sufficient to identify the type of product in the container 18 (ACET) as well as a unique number ranging from 00000 to 99999. Therefore, as long as no more than 100,000 containers of ACETONITRILE were produced, there would be no duplicated labels. In an alternative embodiment of the present invention, those two data strings could be combined into a single data string having values ranging from ACET00000 to ACET99999. The QR code 76 would thereby contain sufficient data to uniquely identify 100,000 individual containers of ACETONITRILE. The QR code 76 could likewise uniquely identify 100,000 individual containers 18 of a different product based on the combination of the product designator and the serialized number.

By including additional data in the QR code 76, or by combining data included in the barcode 74 with data in the QR code 76, the number of unique identifiers can be further expanded. For example, if the first 10,000 of the above labels (e.g., ACET00000 through ACET09999) were also assigned to a particular lot number (lot 0101), the association of the first 10,000 identifier data strings (ACET00000 through ACET09999) with the corresponding lot number (Lot 0101) would allow the identifier strings to be re-used with a different lot number. If data defining the lot number is not included in the QR code 76, the lot number could be used in combination with the identifier data string by the inventory tracking system 10 to uniquely distinguish one container 18 from another container 18 having the same identifier data string, but a different lot number.

Applying the above example to an embodiment of the present invention utilizing multiple printing operations to define the labels 20, one printing operation could produce 100,000 labels including the product designator data (e.g., ACET) in one or more of the barcode 74 and/or in human readable form on the label 20. That is, the human readable information printed on the label 20 would include the product designator (e.g., ACET or ACETONITRILE), the text “Lot Number” followed by a space configured to accept future printing, and the text “Expiration Date” followed by another space configured to accept future printing. However, this first printing operation would not include the QR code 76, lot number, or expiration date on the labels 20 in either machine readable or human readable form.

In response to determining that lot 0101 will be packaged in 10,000 units (or containers 18), a second printing operation would be performed on 10,000 of the 100,000 labels. These labels 20 would thereby be overprinted with “0101” following “Lot Number”, a date following “Expiration Date”, and the QR code 76 containing data fields including the product designator ACET, the lot number 0101, and the serialized numbers 00000 through 09999. Optionally, additional data (such as the expiration date for lot 0101) could also be printed on the labels 20 in either human readable (as is conventional for chemicals and reagents) or machine readable form (as is not conventionally done). In any case, the above data could be formatted in separate data fields, or combined in a single data field. Using the above example, the combined data fields would include unique identifiers ACET-0101-00000 thru ACET-0101-09999.

Embodiments of the present invention include, but are not limited to: (1) embodiments in which the second printing operation is performed before each label 20 is applied to its respective container 18, and before the respective container is filled with the product; (2) embodiments in which a fully printed label 20 is applied to each container 18 immediately after the container 18 is filled with product and sealed; and (3) embodiments in which a fully printed label 20 is applied to each container 18 before the container is filled with product and sealed. In each of the above scenarios, the QR code 76 may optionally contain product invariant data unique to the product in the container 18, such as data describing the inherent characteristics of the product (e.g., user precautions data, product information data, product descriptor data, safety code data, NFPA code data, storage code data, shipper's information data, etc.). Embodiments of the label 20 in which the QR code 76 includes a populated lot number data field may also contain data fields populated with data unique to that lot number (e.g., container variable data). This container variable data may include, but is not limited to: packaging date data, lot expiration date data, and lot analysis data.

In an alternative embodiment of the present invention, the QR code 76, or an additional QR code (not shown) may be printed on the label 20 subsequent to the product being packaged. For example, filled and labeled containers 18 held as inventory at a packaging facility or a downstream distribution facility could be ordered for shipment to a customer. A QR code or other machine readable code applied to the label 20 in response to the container 18 being selected for shipment to the customer could include customer specific or order specific data. For example, the QR code 76 could include a data field populated with purchase order number data. The QR code 76 could also include one or more additional types of data associated with the customer order such as: (1) the order date; (2) the address of a requested delivery location; (3) a requested delivery date; (4) a requirement for certificate of conformity that includes a specific set of specifications; (5) a requirement for a separate delivery of a certificate of analysis or other lot-specific documentation; and (6) a requirement for separate delivery of a material safety data sheet or other product-specific documentation. In embodiments of the present invention including an RFID tag, the aforementioned customer specific or order specific data could be added to the label 20 or container 18 by scanning the RFID tag and writing the additional data to a writable memory in the RFID tag.

Because embodiments in which the QR code 76 includes order specific data (e.g., the order number) have the QR code 76 added to the label 20 after the container 18 has been associated with a particular order, the QR code 76 in these embodiments may also include other container variable or time variable data known at the time the order number is assigned. Examples of container variable data typically known at the time the order number is assigned include the product lot number and the unique identifier of the container 18 (e.g., ACET-0101-00234 for the 234th bottle from lot 0101 of product ACET).

In an embodiment of the present invention, the QR code 76, or an additional QR code, may be added to the container 18, either to the label 20 or as an additional label, at one or more locations between the packaging location and the location where the container 18 is ultimately received and the product contained therein used. A QR code 76 applied upstream of a distribution location may also be read at the distribution location so that the inventory tracking system 10 can update data stored in the database 50 regarding the status of the container 18. This tracking may performed whether or not a second QR code is applied to the label 20, or affixed to the container 18 in some other manner, at the intermediate distribution location.

In embodiments of the present invention including an RFID tag, the RFID tag may be integrated with the container 18 at the point of manufacture, added to the container 18 at a downstream location, or embedded in the label 20. RFID tags typically include an integrated circuit, or chip, that includes memory and an input coupled to a small coil which serves as an antenna. Data that uniquely identifies the RFID tag (e.g., a serial number) is stored in the memory of the chip. In response to activation by a suitable radio frequency (RF) signal, the RFID tag acts as a transponder and transmits the identification data stored in the chip to a reader.

The RFID tag may be powered by the activation RF signal (i.e., the RFID tag is “passive”), or may also be powered by an internal battery (i.e., the RFID tag is “active”) to extend the range at which the RFID tag can be read. RFID tags may be read-only (the data may be read but not changed), read/write (the data can be read and/or changed), or a combination in which a portion of the data is read only, while another portion may be changed. RFID tags that are read only may provide similar data storing features as the QR code 76. In contrast, RFID tags having writable memory allow stored data to be updated. Updating the data in a writable RFID tag may enable a single RFID tag to provide features similar to those described herein which involve adding an additional QR code to the container 18. RFID tags may also allow data to be read from the container 18 at downstream locations without removing the container 18 from a case or pallet. To this point, a label including one or more printed machine readable codes could also be affixed to a case or pallet. This pallet label could include copies of the machine readable codes on the labels 20 of containers 18 in the case (in which multiple bottles are contained) or pallet (onto which multiple cases, each with multiple bottles, have been stacked and held in place with wire bands) so that data about multiple individual containers can be obtained by scanning the pallet label rather than unstacking the pallet or opening one or more individual cases to access each of the multiple containers 18 in each case or on each pallet.

An exemplary sequence of label printing and affixing to containers 18 may include a label being printed and applied to a container 18 that is filled with product and sealed. The container 18 may then be packaged for shipment as a single container (e.g., 500 ml, 1 L, 2.5 L or 4 L) or as a case (e.g., 6×500 ml, 6×1 L, 4×2.5 L or 4×4 L) with another label 20 applied to the exterior of the shipping container. The label 20 on the exterior of each case may have information common to all of the containers 18 in the case, or could have separate QR codes 76 with each code corresponding to a container 18 in the case.

The case of containers 18 may then be shipped to a distribution center or warehouse. At the distribution center, an optional additional (or secondary) label 20 may be applied to the case or to each container 18 in the case after the order is received and before shipping an entire case or cases or shipping individual containers (repacked into an appropriate shipping case) to a customer location. The QR code 76 of the secondary label could then include the PO number and delivery location, for example. The container or case may then be shipped to the customer location, where it is received, for example, on a receiving dock.

Once at the customer location, the container 18 or case of containers 18 may be delivered to an appropriate stockroom, classroom, lab, etc. and put away in a bin or on a shelf. The label 20 of each container 18 may be scanned each time chemical or reagent is removed from the container and/or the container is checked out to track the amount of chemical or reagent remaining in the container 18 as well as the location of the container 18. At each step of the process, the label 20 may be scanned so that the container 18 is tracked from the point of production until the chemical or reagent it contains is fully consumed by a customer.

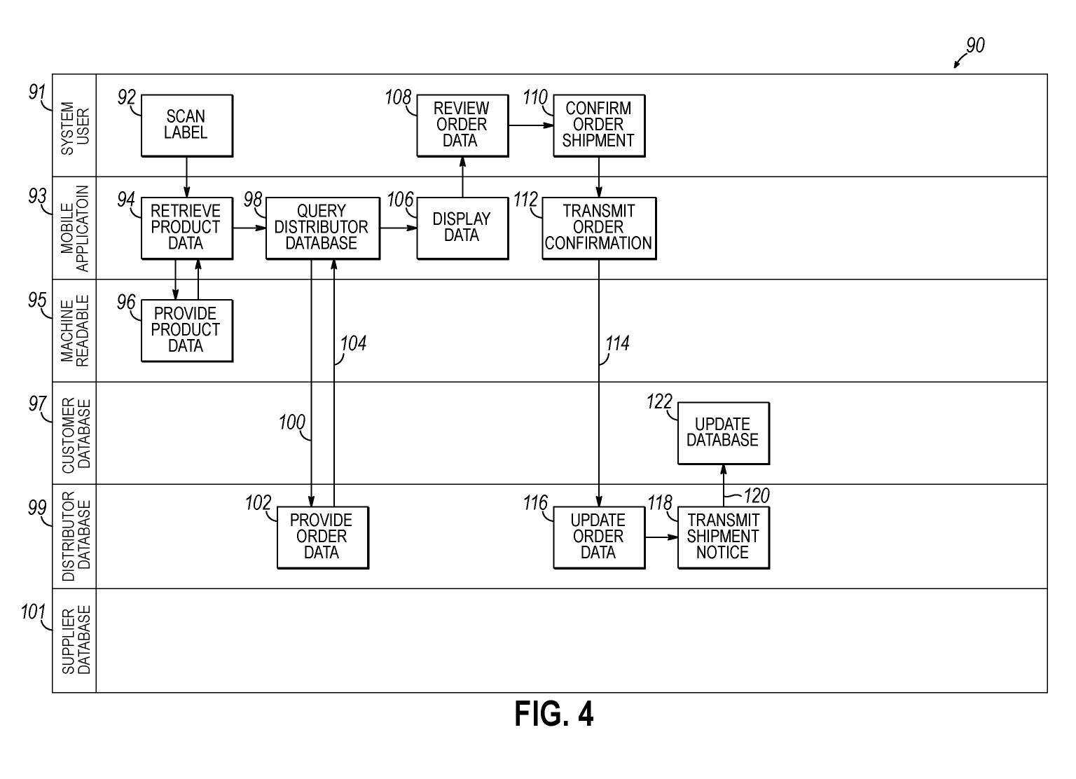

Referring now to FIGS. 4-8, flow charts are presented including a row 91 having function blocks that illustrate actions taken by the system user, a row 93 having function blocks that illustrate actions taken by the mobile application 34, a row 95 having function blocks that illustrate actions taken by the machine readable code(s) 74, 76 or RFID tags of label 20, a row 97 having function blocks that illustrate activities of the customer database 58, a row 99 having function blocks that illustrate activities of the distributor database 59, and a row 101 having function blocks that illustrate activities of the supplier database 60.

It should be understood, however, that the arrangement of functions shown in FIGS. 4-8 is for exemplary purposes only. Persons having ordinary skill in the art will understand that in alternative embodiments of the present invention, some of these functions could be reallocated between the mobile application 34, the machine readable codes 74, 76, and the system databases 58-60. In addition, one or more of the application 34 and/or databases 58-60 could be integrated on a single system or platform. Moreover, persons having ordinary skill in the art will further understand that the databases 58-60 may include data stored in one or more of the mobile device 12, one or more hardware platforms 14, on servers in the network 16 (e.g., in what is commonly referred to as “the cloud”), and/or in the machine readable code 74, 76. Data may also be cached in the mobile device 12 to facilitate operation of the mobile application 34. Embodiments of the present invention are therefore not limited to the structures illustrated in FIGS. 4-8.

Referring now to FIG. 4, a flow chart 90 illustrates a process in accordance with an embodiment of the present invention whereby a container 18 may be tracked in, for example, a distribution center. In block 92, a system user working in the distribution center scans the label 20 of a container 18 that is being shipped to a customer by activating the scanning function on mobile device 12. In block 94, the mobile device 12 scans the label 20 to retrieve product data from one or more of the machine readable codes (e.g., the QR code 76) on the label 20. In block 96, the product data is provided by the machine readable code and/or other devices of label 20. This data may include a product descriptor, the product lot number, the unique identifier data, or any other data relating to the container 18 or the product within the container stored in machine readable form on the label 20.

In response to receiving the product data from label 20, the mobile application 34 may proceed to block 98. In block 98, the mobile application 34 transmits a query 100 to a computing resource of inventory tracking system 10, such as the distributor database 59. The query 100 may be in any suitable machine readable format, such as Extensible Markup Language (XML), and includes data obtained from the label 20 sufficient to allow the distributor database 59 to identify the specific container 18 to which the label 20 is attached.

In response to receiving the query 100, the distributor database 59 proceeds to block 102 and transmits a response 104 that includes data relating to the container 18. This data may include, for example, a purchase order number, customer shipping address, and/or electronic addresses of the customer and/or supplier databases 58, 60. In response to receiving the response 104, the mobile application 34 proceeds to block 106 and displays data to the system user based on the received product data. The mobile application 34 may also present one or more choices to the system user, such as a confirm order window displayed on the user interface 28 that includes selectable YES and NO buttons. In block 108, the system user reviews the order data before proceeding to block 110 and confirming the order by, for example, activating the YES button on the user interface 28.

In response to the system user confirming the order, the mobile application 34 may proceed to block 112 and transmit an order confirmation 114 to the distributor database 59. In response to receiving the order confirmation 114, the database 59 proceeds to block 116 and updates the data in the database 59 to reflect the shipment of the container 18. The database 59 may then proceed to block 118 and transmit a message 120 to the customer database 58, such as an advanced shipment notice including data regarding the container 18 and the shipment. In response to receiving the communication 120, the customer database 58 may proceed to block 122 and update its data to include data relating to the container 18 that was included in the electronic communication 120. This update may include creating an object in the database 58 and associating this object with the inbound container 18.

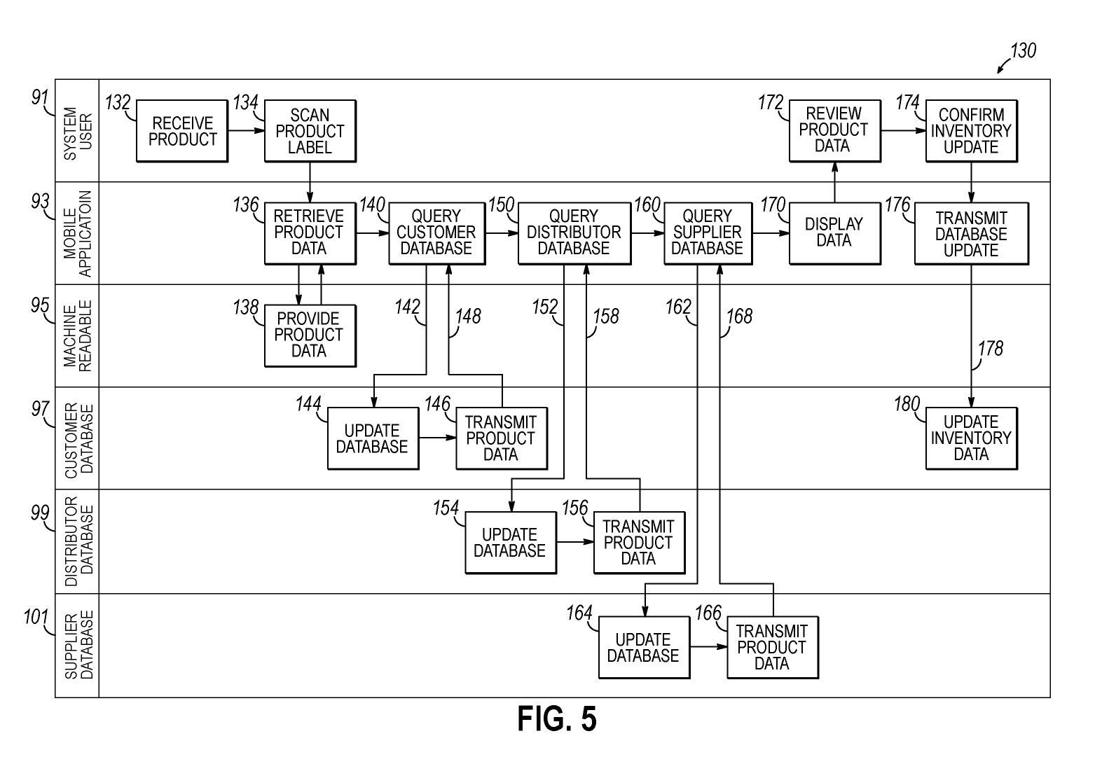

Referring now to FIG. 5, a flow chart 130 is presented that illustrates an embodiment of the present invention that updates the customer database 58 in response to the container 18 being delivered to the customer. In block 132, the container 18 is delivered to a customer location. The delivery location may be a central customer location that receives containers 18 for multiple customer stockrooms, a customer stockroom, or some other suitable location. In block 134, a system user, such as an employee of the customer, scans the label 20 of the delivered container 18 by activating the mobile device 12. In block 136, the mobile application 34 scans the label 20 in response to activation by the system user, and retrieves data from one or more of the machine readable codes. In block 138, the machine readable code provides the product data. The product data includes data sufficient to identify the container 18 as being the container 18 identified in the electronic communication 120 received from the distributor database 59 as described above with respect to FIG. 4. In response to receiving the data from the label 20, the mobile application 34 proceeds to communicate with one or more of the databases 58-60.

To this end, the mobile application 34 may proceed to block 140 and transmit a query 142 to the customer database 58. In block 144, the customer database receives the query 142. In response to receiving the query 142, the customer database 58 may update the database object associated with the container 18 to reflect that the container 18 has been received by the customer. This update may include storing the time and date the container 18 was received, as well as any other data regarding receipt of the container, such as the location where the container 18 was received and/or who received it, before proceeding to block 146. In block 146, the customer database 58 transmits a response 148 to the mobile application 34 that includes data relating to the container 18. The data transmitted in the response 148 may include data that was previously received from the distributor database 59 in the electronic communication 120. In response to receiving the response 148, the mobile application 34 may proceed to block 150.

In block 150, the scanner application optionally transmits a query 152 to the distributor database 59. The query 152 may contain data read from the QR code 76 that positively identifies the container 18 so that the distributor database 59 can update its data to reflect that the container 18 has been received by the customer. In an alternative embodiment of the present invention, the query 152 may be transmitted to the distributor database 59 directly from the customer database 58. The mobile application 34 may also give the user to option of not transmitting the query 152 to the distributor database 59 by requesting the user authorize transmission before the query 152 is sent.

In any case, in response to receiving the query 152, the distributor database 59 proceeds to block 154 and updates its data. The distributor database 59 then proceeds to block 156 and transmits a response 158 to the mobile application 34. In response to receiving the response 158, the mobile application 34 may optionally proceed to block 160 and transmit a query 162 to the supplier database 60. As with the queries 142, 152 to the customer and distributor databases 58, 59, the query 162 to the supplier database 60 may contain data read from the label 20 that positively identifies the container 18. The supplier database 59 can thereby correlate the data in the query 162 to the specific container 18 to update and/or return data specific to that container 18. Although not shown, the query 162 may also be transmitted to the supplier database 60 directly from either of the customer or supplier databases 58, 59. The mobile application 34 may also give the user to option of not transmitting the query 162 to the supplier database 60 by requiring the user authorize the transmission before the query 162 is sent.

Similarly as described above with respect to the distributor database 59, the supplier database 60 may update its data in block 164 before proceeding to block 166 and transmitting a response 168 to the mobile application 34. In response to receiving the response 168, the mobile application 34 may proceed to block 170 and display data to the user indicating that the inventory tracking system 10 has acknowledged receipt of the container 18. In block 172, the user reviews the displayed data before proceeding to block 174 and confirming the inventory update. In response to the user confirming the inventory update, the mobile application 34 may proceed to block 176 and transmit a message 178 to the customer database 58. The message 178 may include data relating to the container 18 or the product sample in the container 18 that was received in one of the responses 158, 168. In response to receiving the message 178, the customer database 58 may proceed to block 180 and update the data object associated with the specific container 18 so that the database 58 reflects the most current data on the container 18.

In an embodiment of the present invention, the mobile device 12 may include data related to its location in queries or other messages transmitted to the databases 58-60. This location data may be based on a location assigned to the mobile device 12, a location determined by the mobile device 12 using a location technology such as the Global Positioning System (GPS), or a location entered or selected by the user, such as from a selectable list of locations (e.g., “Receiving Dock”, “Stockroom A”, “Stockroom B”, etc.). The mobile application 34 may include data identifying its location in one or more of the queries or messages 142, 152, 162, 178 along with the unique identifier (e.g., ACET-0101-00234). In this way the inventory system 10, and in particular the customer database 58, can track the location of the container 18 each time the label 20 is scanned. This data may allow the customer database 58 to track that a specific container 18 was, for example, received on a particular date at the customer's central receiving location. In an embodiment of the present invention, the customer database 58 may automatically update the location of the container 18 each time the label 20 is scanned to help users locate the container 18.

Using the location feature, the customer database 58 may track whether the container 18 was delivered to the intended location by comparing the current location to location data included in the advanced shipment notice message 120. The customer database 58 may also associate the received container 18 with the customer's purchase order number to determine specific customer requirements identified in the purchase order. These associations may be made based on the unique identifier and/or other product data included in the machine readable code of label 20. The inventory tracking system 10 may thereby facilitate tracking down lost containers 18 as well as identifying containers 18 that do not meet the customer's requirements of specifications (e.g., that are not accompanied by certificate of conformity) so that non-compliant product deliveries can be refused.

The inventory tracking system location feature may also provide advantages for customers that maintain a central stockroom that supplies products to multiple locations. For example, a school may have a central stockroom that supplies chemicals to multiple classrooms or laboratories. In these environments, the stockroom will typically only keep one or two containers 18 of a specific chemical on hand at a time. When the chemical is needed in a particular laboratory or classroom, the container 18 of that chemical may be removed from the stockroom by a teacher or laboratory technician. If the person using the container does not return it promptly, or fails to note that where the container is being taken, the stockroom may lose track of the container 18. However, by loading the mobile application 34 onto a smart phone or some other suitable device, a user of the container 18 can quickly and simply update the location of the container 18 by scanning the label 20 of the container 18 using the smart phone. Another user needing to use the chemical, or a stockroom employee wishing to track down a missing container, could then quickly locate the container 18 by accessing the customer database 58.

The container location tracking feature of the inventory tracking system 10 may also be used to support or enhance other inventory tracking features. For example, if the label 20 is scanned each time the container 18 is opened and a chemical or reagent withdrawn, the customer database 59 can track the specific container 18 from which a chemical was sourced for a particular instance of the chemical being used for a research, quality control, synthesis, production or other purpose. To this end, and in accordance with an embodiment of the present invention, the label 20 of container 18 may be scanned each time the container 18 enters a building, room, or other location where the container 18 is intended to be used. This scanning may be performed when the container 18 is first received at the location in question, and/or during the performance of an inventory check of containers 18 at the location. Advantageously, this scanning may be performed by any user that has loaded the mobile application 34 onto their smart phone. This added convenience may increase user compliance with rules requiring that containers 18 be scanned each time they are moved or used.

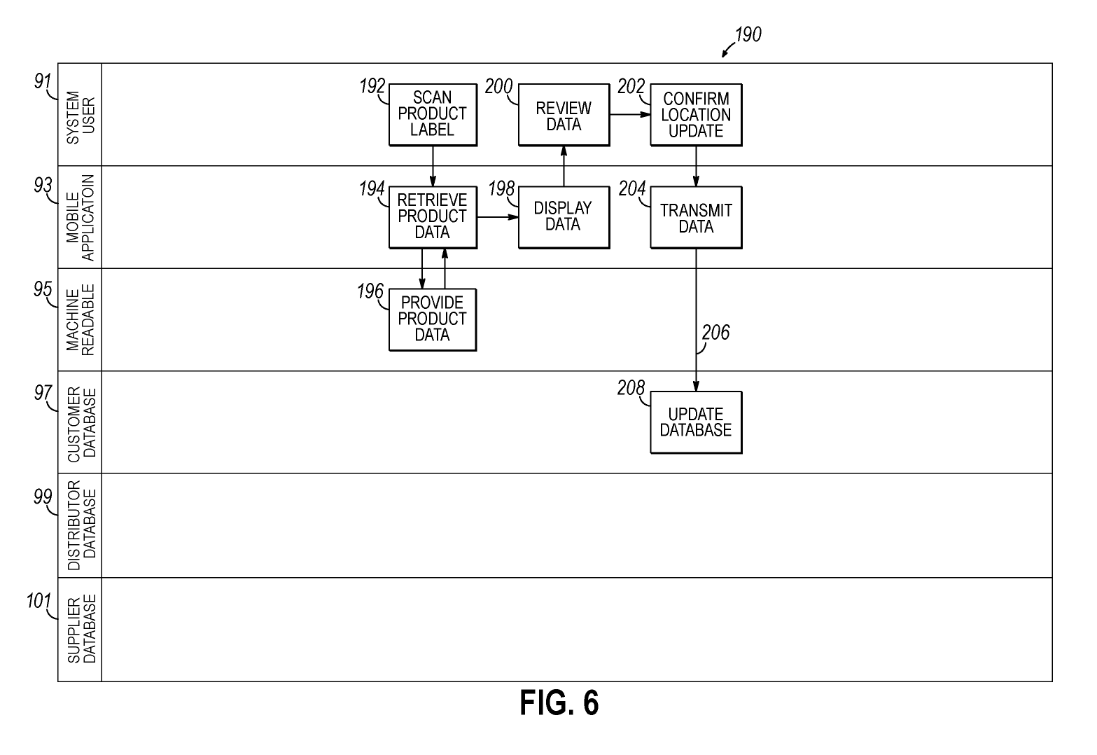

Referring now to FIG. 6, a flow chart 190 is presented that illustrates a process by which the location of the container 18 may be updated in the inventory tracking system 10. In block 192, the user initiates the process by activating the mobile device 12. In block 194, the mobile application 34 scans the label 20 in response to activation by the system user, and retrieves data from one or more of the machine readable codes 74, 76. In block 196, the machine readable code 74, 76 provides the product data, which may include data sufficient to uniquely identify the container 18 within the inventory tracking system 10. In response to receiving the data from the label 20, the mobile application 34 proceeds to block 198.

In block 198, the mobile application 34 displays data to the system user. This data may include information identifying the container 18, the product sample in the container, and/or the current location of the mobile device 12. In block 200, the user reviews the data before proceeding to block 202. In block 202, the user confirms that the location displayed on the user interface 28 of mobile device 12 is the current location of the container 18. As described above, the current location may be determined automatically by the mobile device 12. If the mobile device 12 is unable to determine its location, the user may enter the location into the mobile device 12. Location entry may be performed manually, by scanning a machine readable label or device that includes location data (e.g., a barcode affixed to a wall, door, shelf, or bin that includes location data, such as a room number), by selecting a location from a plurality of locations presented by the mobile device 12, or by asking the mobile device 12 to determine its location.

In response to the user confirming the location of the mobile device 12, the mobile application 34 may proceed to block 204 and transmit a message 206 to the customer database 58. The message 206 may include data that identifies the container 18 (e.g., the unique identifier ACET-0101-00234) and the current location of the mobile device 12. In response to receiving the message 206, the customer database 58 may proceed to update the location associated with the container 18 in the database 58. The customer database 58 may thereby track the last known location of the container 18.

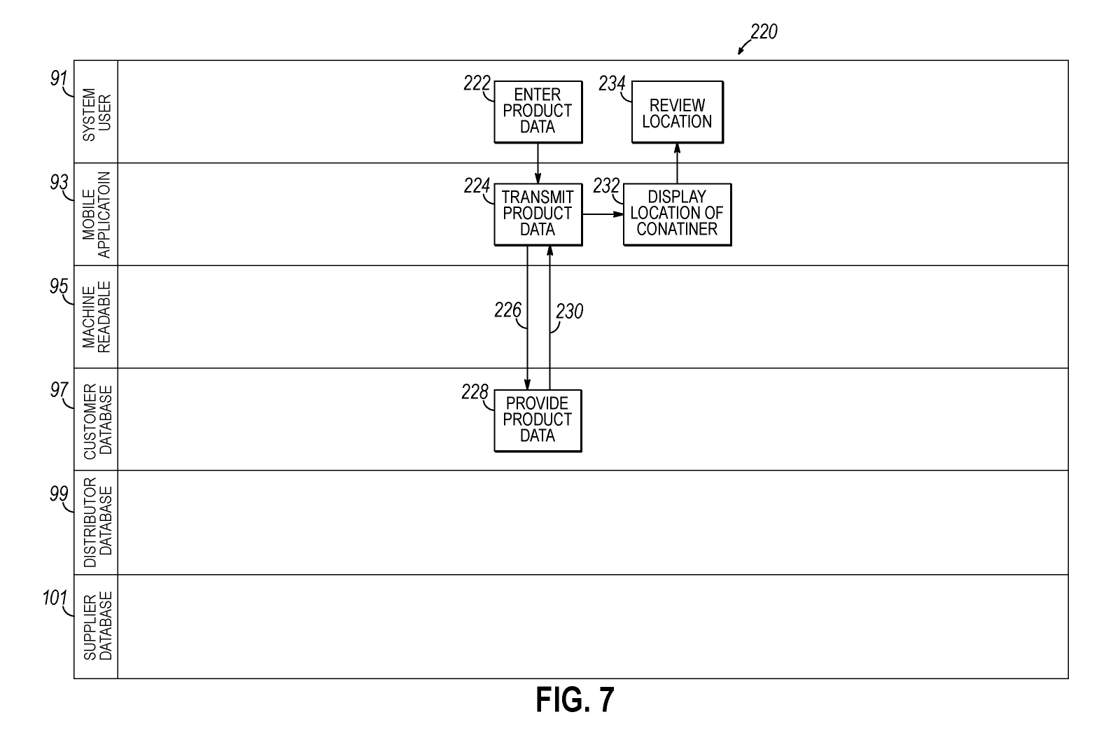

Referring now to FIG. 7, a flow chart 220 is presented that illustrates an exemplary process by which the inventory tracking system 10 may facilitate locating a container 18. In block 222, a system user wishing to locate the container 18 enters product data into the user interface 28 of mobile device 12. The product data may be the name of the product (e.g., “ACETONITRILE”), a catalog number, or any data that may be used to identify the container 18, or narrow down the number of containers 18. In block 224, the mobile application 34 transmits a message 226 to one of the databases 58-60 (e.g., the customer database 58) that includes the product data entered by the user. In response to receiving the product data, the customer database 58 proceeds to block 228 and searches for containers 18 in inventory that match the product data entered by the user. For example, in response to the user entering “ACETONITRILE”, the customer database 58 may identify all the containers 18 currently in inventory containing that chemical, as well as each container's last known location. The customer database 58 may then transmit a response 230 to the mobile application 34 that includes data identifying the containers 18 and their locations, or if no containers 18 match the search terms, an error message. In response to receiving the response 230, the mobile application 34 proceeds to block 232 and displays the containers 18 matching the user's search terms and their locations. In block 234, the user reviews the results of the search. The user may then select one of the displayed containers 18, and/or enter a new search term. In an embodiment of the present invention, the user may also enter an amount of the chemical that is needed in block 222. In this embodiment, the customer database 58 may further limit the containers 18 identified to those that contain enough chemical to satisfy the user's requirements.

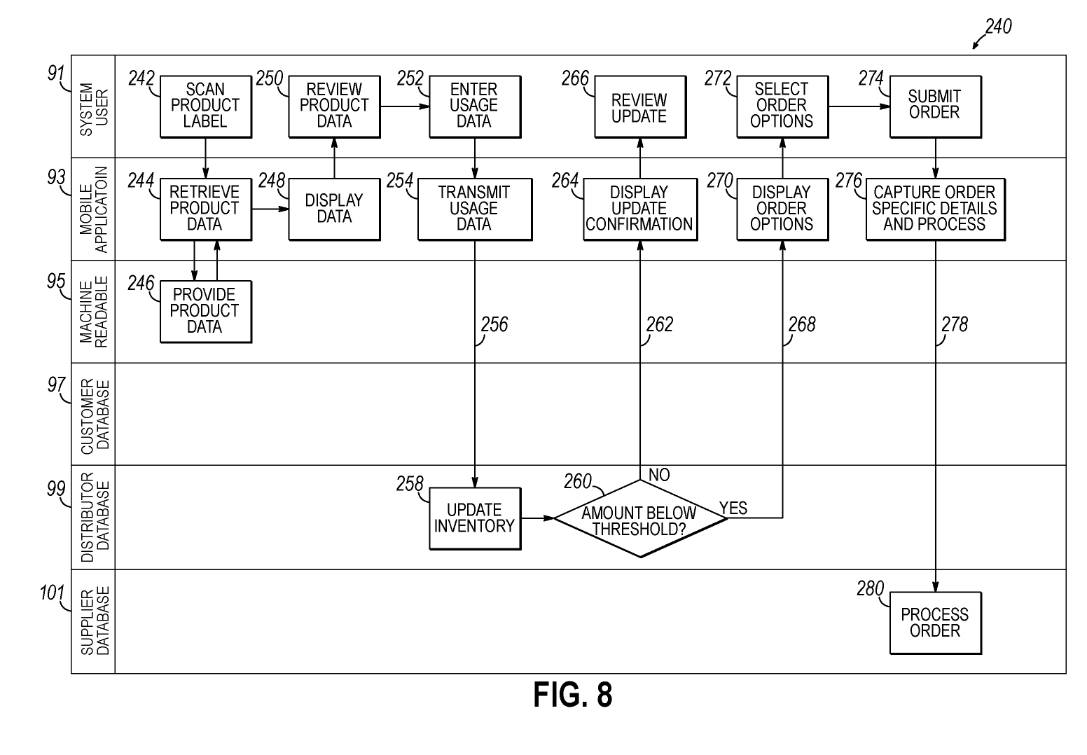

Referring now to FIG. 8, a flow chart 240 is presented that illustrates a process by which the inventory tracking system 10 tracks usage of the product sample in the container 18 in accordance with an embodiment of the present invention. In block 242, the user initiates the process by activating the mobile device 12 to scan the label 20. In block 244, the mobile application 34 scans the label 20 in response to activation by the system user, and retrieves data from one or more of the machine readable codes 74, 76. In block 246, the machine readable code provides the product data, which may include data sufficient to uniquely identify the container 18 within the inventory tracking system 10. In response to receiving the data from the label 20, the mobile application 34 proceeds to block 248.

In block 248, the mobile application 34 displays the retrieved data to the system user. This data may include information identifying the container 18, the product in the container, and/or the current location of the mobile device 12. In block 250, the system user reviews the data to verify that it matches the container 18 before proceeding to block 252. In block 252, the user enters data concerning usage of the product in the container 18. The usage data may include an amount of chemical or reagent product being removed from the container 18 (e.g., for use in an experiment), an amount of product remaining in the container (e.g., from weighing the container 18 as part of an inventory audit), or any other data concerning use of the product. The user may also verify the location displayed on the user interface 28 of mobile device 12 is the current location of the container 18, enter a location, or select a location displayed on the user interface 28 of mobile device 12 as described above with respect to FIG. 6.

In response to the user entering the product usage data, the mobile application 34 may proceed to block 254 and transmit a message 256 to the customer database 58. The message 256 may include data that identifies the container 18 (e.g., the unique identifier ACET-0101-00234), the usage data, and optionally, the location data. In response to receiving the message 256, the customer database 58 may proceed to block 258 and determine the amount of product left in the container 18. The customer database 58 may then update the inventory data (e.g., a data field in a database object associated with the container 18) to reflect the amount of the product left in the container 18 before proceeding to optional decision block 260.

In decision block 260, the customer database 58 compares the amount of chemical or reagent product remaining in the container 18 to a threshold amount of product. This threshold amount of product may, for example, be defined by the customer to reflect a minimum amount of product that the customer wants to maintain in inventory. If the amount of product remaining is not below the threshold amount (“NO” branch of decision block 260), the customer database 58 may transmit a message 262 to the mobile application 34 that simply confirms the inventory update. In response to receiving the message 262, the mobile application 34 may proceed to block 264. In block 264, the mobile application 34 displays an update confirmation to the system user, which is reviewed by the system user in block 266.

If, on the other hand, the amount of product remaining in the container 18 is below the threshold amount, or brings the total amount of product on hand below the threshold amount (“YES” branch of decision block 260), the customer database 58 may transmit a message 268 to the mobile application 34 that includes restocking options. To this end, the message 268 may include data regarding options for ordering a new container 18 of the product, such as catalog numbers and vendors from which the container 18 may be ordered. In response to receiving the message 268, the mobile application 34 may proceed to block 270 and display the restocking options to the system user. In block 272, the system user selects an order option and proceeds to block 274, where the user submits the order by, for example, activating a “SUBMIT ORDER?” button displayed on a touchscreen of the user interface 28.

In response to the user submitting the order, the mobile application 34 may proceed to block 276 and transmit a message 278 to the supplier database 60 or some other suitable vendor system for filling the order. In block 280, the supplier database 60 processes the order. In an alternative embodiment of the present invention, the customer database 58 may send the message 268 to a mobile application 34 for a different user than the one performing the usage update, such as a stockroom manager. The customer database 58 may also be configured to automatically send a requisition or other message to the supplier or distributor, such as an e-mail notifying a sales representative that the customer is running low on a product. The customer database 58 may also be configured to automatically generate and transmit an order directly to the supplier database 60.

By determining and entering (either manually or systematically) the quantity of product withdrawn from the container 18 each time the product is used, each quantity withdrawn can be (1) associated with a specific use record; and (2) subtracted from the quantity of product in an inventory record. In this way, the customer database 58 may keep track of the current amounts of products in inventory and their locations. System users thereby have access to current data regarding to the amounts of products present in various rooms, laboratories, or other customer locations. This feature is particularly useful in generating reports on aggregate contents of particular chemicals to governmental and regulatory authorities, and in auditing the underlying data contained in such reports by periodic comparisons of the data in the database to what may be physically observed by an auditor or inspector. This data may be particularly useful with respect to hazardous chemicals or other products that may pose a danger to employees or emergency responders, and which are required by law or regulation to be reported periodically and/or made available upon request to certain individuals. In addition, usage trends could be identified and used to adjust the desired minimum and maximum amounts of product to keep on hand.

Thus, the mobile application 34 may be used to record the removal of a specific container 18 from one location and the receipt of the container 18 at another location, as well as the amount of product used at each location. This inventory tracking data may provide the basis for multiple inventory tracking features. For example, the customer database 58 may track locations and amounts of product in all containers 18 of a specific product (e.g., ACETONITRILE) that are on site at the customer's facility. Then, when a project in one location calls for a specific amount of the product, a container 18 of the product may be delivered to the location that contains at least that amount of product. To this end, in response to a request for the product, the customer database 58 may identify a container 18 containing at least enough of the product to satisfy the request. The customer database 58 may then issue an order to move the container 18 from its current location (e.g., a stockroom or laboratory) to the location specified in the request. Upon delivery, the container label 20 may be scanned by the mobile application 34, the required amount of product removed, and the location and amount of product remaining updated as described above. If product remains in the container 18, the container 18 may be returned to the central stockroom and its receipt in the stockroom recorded by the mobile application 34 so that the container 18 is available for subsequent projects based on the amount of product remaining in the container 18.

While the present invention has been illustrated by the description of embodiments thereof, and while these embodiments have been described in considerable detail, it is not the intention of the applicant to restrict or in any way limit the scope of the appended claims to such detail. Additional advantages and modifications will readily appear to those skilled in the art. Therefore, the present invention in its broader aspects is not limited to the specific details of the representative apparatus and method, and illustrative examples shown and described. Accordingly, departures may be made from such details without departing from the spirit or scope of applicants' general inventive concept.

For example, although the inventory tracking system processes are illustrated in FIGS. 4-8 and described above as a generally linear sequence, persons having ordinary skill in the art will understand that system messages may be transmitted in different sequences or even concurrently. Moreover, additional functions and queries may be performed during the data retrieval process. For example, the user may proceed to other parts of the various system applications while data is being retrieved. Embodiments of the present invention are thus not limited to performing the shown functions in a particular sequence, or storing data in a particular location. It should also be understood that the terms “query”, “response”, “confirmation”, and/or “message” as used herein are considered interchangeable. Use of any one of these terms is therefore not intended to imply that any particular quality is associated with regard to type of signal being used to transmit or receive the “query”, “response”, “confirmation”, and/or “message”. Nor is any there to be any implication regarding the nature of the data conveyed by a signal based on the use of the term “query”, “response”, “confirmation”, and/or “message” in describing said signal or the data conveyed thereby.

What is claimed is:

1. A method of tracking a container of a product using a reading device, the method comprising:
providing a first machine readable code on the container, the first machine readable code including first data that uniquely identifies the container;
providing second data to a database, the second data relating to the container and/or a product in the container;
associating the first data and the second data in the database;
receiving a message in the database that includes the first data and third data; and
updating the second data in the database based on the third data in the message, the third data being time variable data relating to events associated with the container.

2. The method of claim 1 wherein the first data includes at least one of data defining a lot number of the product in the container, a lot analysis of the product in the container, an expiration date of the product in the container, and a serial number of the container.

3. The method of claim 1 further comprising:
retrieving the first data by reading the machine readable code with the reading device;
in response to retrieving the first data, transmitting the first data from the reading device to the database; and
in response to transmitting the first data to the database, receiving the second data from the database in the reading device.

4. The method of claim 3 wherein the second data includes data relating to at least one of a location of the container, an amount of the product in the container, a status of the container, and a purchase order for the container.

5. The method of claim 3 wherein the third data is transmitted to the database from the reading device.

6. The method of claim 5 wherein the third data includes data relating to at least one of a location of the container, an amount of the product in the container, a status of the container, and a purchase order for the container.

7. The method of claim 1 further comprising:
providing a second machine readable code on the container, the second machine readable code including fourth data relating to an event associated with the container.

8. The method of claim 7 wherein the first machine readable code is provided on the container by a product supplier, and the second machine readable code is provided on the container after the container has shipped from the product supplier.

9. The method of claim 7 wherein the event is an event related to shipment of the container.

10. The method of claim 9 wherein the fourth data includes at least one of a purchase order number, an order shipping date, a desired delivery location, a desired delivery date, a notification of a requirement for a certificate of conformity, a notification of a requirement for a certificate of analysis, and/or a notification of a requirement for a material safety datasheet.

11. The method of claim 1 wherein providing the first machine readable code on the container includes:
adding the first machine readable code to a label; and
placing the label on the container.

12. The method of claim 11 further comprising:
adding a second machine readable code to the label on the container, the second machine readable code including fourth data relating to an event associated with the container, and being added after the first machine readable code has been added to the label, and after the label has been placed on the container.

13. The method of claim 1 wherein the reading device includes a scanning device.

14. A method of tracking a container of a product using a reading device, the method comprising:
providing a machine readable code on the container, the machine readable code including first data that uniquely identifies the container;
providing second data to a database, the second data relating to the container and/or a product in the container;
associating the first data and the second data in the database;
reading the machine readable code on the container with the reading device;
transmitting a message to the database from the reading device, the message including data indicative of an amount of the product; and
updating the second data in the database based on the data indicative of the amount of the product.

15. The method of claim 14 further comprising:
entering the amount of the product into the reading device, wherein the amount of product is an amount of product removed from the container or an amount of product remaining in the container.

16. The method of claim 14 further comprising:
entering an intended use of the amount of product into the reading device, the message transmitted to the database further including data regarding the intended use of the product; and
updating the second data in the database based on the data indicative of the intended use of the product.

17. The method of claim 14 further comprising:
determining a location of the reading device;
including data regarding the location of the reading device in the message transmitted to the database; and
updating the second data in the database based on the data indicative of the location of the reading device.

18. The method of claim 17 wherein the location of the reading device is automatically determined by the reading device in response to reading the machine readable code on the container.

19. A label for labeling one of a plurality of containers of a product, the label comprising:
a first machine readable code including first data that uniquely identifies the one container by indicating:
a unique number that is not repeated across a product or container,
a combination of a number and a product designator that can occur on only one container of the plurality of containers, or
a combination of a serial number, a product identifier, and a lot number that can occur on only one container of the plurality of containers, wherein
the first data is associated in a database with second data relating to the container.

20. The label of claim 19 wherein the first data further includes at least one of a lot analysis of the product in the container and an expiration date of the product in the container.

21. The label of claim 19 further comprising:
a second machine readable code including third data relating to an event associated with the container.

22. The label of claim 21 wherein the event associated with the container is an event related to shipment of the container.

23. The label of claim 22 wherein the third data includes one or more of a purchase order number, an order shipping date, a desired delivery location, a desired delivery date, a notification of a requirement for a certificate of conformity, a notification of a requirement for a certificate of analysis, and a notification of a requirement for a material safety datasheet.

24. A system for tracking a container of a product using a reading device, the system comprising:
a processor; and
a memory, the memory storing instructions that, when executed by the processor, cause the processor to:
provide a first machine readable code on a container, the first machine readable code including first data that uniquely identifies the container;
provide second data to a database, the second data relating to the container and/or a product in the container;
associate the first data and the second data in the database;
receive a message in the database that includes the first data and third data; and
update the second data in the database based on the third data in the message, the third data being time variable data relating to events associated with the container.

25. A computer program product comprising:
a non-transitory computer readable storage medium; and
program instructions stored on the computer readable storage medium that, when executed by a processor, cause the processor to:
provide a first machine readable code on a container, the first machine readable code including first data that uniquely identifies the container;
provide second data to a database, the second data relating to the container and/or a product in the container;
associate the first data and the second data in the database;
receive a message in the database that includes the first data and third data; and
update the second data in the database based on the third data in the message, the third data being time variable data relating to events associated with the container.
